(19) United States
(12) Patent Application Publication
(10) Pub. No.: US 2025/0123371 A1
(43) Pub. Date: Apr. 17, 2025

(54) LIDAR SENSOR DEVICE AND MEASURING METHOD

(71) Applicant: ams-OSRAM International GmbH, Regensburg (DE)

(72) Inventors: Josip MARIC, Sinzing (DE); Alexander MARTIN, Sinzing (DE)

(21) Appl. No.: 18/682,131

(22) PCT Filed: Aug. 9, 2022
(86) PCT No.: PCT/EP2022/072382

§ 371 Date: Feb. 8, 2024

(30) Foreign Application Priority Data
Aug. 10, 2021 (DE) 10 2021 120 807.6

(51) Int. Cl. G01S 7/484; G01S 7/481; G01S 7/4865; G01S 17/931

(52) U.S. Cl. CPC G01S 7/484; G01S 7/4815; G01S 7/4816; G01S 7/4817; G01S 7/4865; G01S 17/931

(57) ABSTRACT

A LIDAR sensor device includes a first laser emitter configured to emit pulsed light of a first wavelength and at least one second laser emitter configured to emit pulsed light of at least a second wave-length different from the first wavelength, in the direction of an object located in front of the laser emitters respectively. Furthermore, the sensor device includes a receiving unit including at least one photodetector, as well as a first and at least one second optical bandpass filter, in particular a narrowband optical bandpass filter, wherein the first and the at least one second optical bandpass filter are arranged between the object and the at least one photodetector, and wherein the first bandpass filter is configured to allow substantially light of the first wavelength to pass and the at least one second band-pass filter is configured to allow substantially light of the at least one second wavelength to pass.

The present application is a U.S. National Stage Application of International Application PCT/EP2022/072382, filed on August 9, 2022 and claims the priority of the German application DE 10 2021 120 807.6 of Aug. 10, 2021, the entire disclosures of the above-listed applications are hereby incorporated by reference.

### FIELD

Various embodiments of the present disclosure relate to a LiDAR sensor device and a measurement method for determining the distance between a LiDAR sensor device and an object located in front of the sensor device.

### BACKGROUND

LiDAR (Light Detection and Ranging) technology for environmental detection is well known and is used in particular in vehicle and space technology for autonomous systems. The measuring principle used is time-of-flight (ToF) measurement, whereby an emitter generates an optical signal to illuminate an object space and a detection unit records the echo signal reflected back from an object located there based on the time of flight. Class 1 lasers in the near infrared or infrared range (780 nm-1.6 μm), which are harmless to the human eye, are often used as emitters. Although it is possible to use a continuously emitting laser for a LiDAR system, emitters in pulsed mode are usually preferred to reduce the noise signal caused by ambient light effects.

An increasing number of vehicles or autonomous systems, for example in road traffic, which are equipped with LiDAR technology for environmental detection, can lead to the systems having problems distinguishing between an echo signal reflected from an object and light emitted by another system. In particular, when LiDAR systems use lasers that emit light of the same wavelength, it can be difficult to distinguish between light reflected from an object and light emitted by another system. In particular, the light emitted by another system or several other systems can lead to an increase in a measured noise signal and thus to a more difficult interpretation of the signal measured by the detector. However, the correct interpretation of a real situation is crucial for the system to take the right action.

There is therefore a need to specify a LiDAR sensor device, in particular for autonomous systems, which counteracts at least one of the aforementioned problems. Furthermore, there is a need to specify an improved measurement method for determining the distance between a LiDAR sensor device and an object located in front of the sensor device.

### SUMMARY

A LiDAR sensor device includes an illumination system for emitting pulsed illumination radiation into an object space and a detection or receiver unit with an image sensor, in particular a photodetector, for detecting the radiation reflected back from the object space.

To solve aforementioned problems, it is possible is to encode the illumination radiation emitted by the illumination system in such a way that an echo signal reflected from an object can be clearly identified, and/or to select precisely the wavelength with the best signal-to-noise ratio from several different light beams of different wavelengths emitted by the illumination system as the measurement wavelength.

In addition to a first emitter, the LiDAR sensor device includes at least one second emitter, for example, an NIR or IR laser (near infrared or infrared), wherein the first emitter is configured to emit pulsed light of a first wavelength and the at least one second emitter is configured to emit pulsed light of at least a second wavelength, which differs from the first wavelength, in the direction of an object located in front of the laser emitters respectively. In addition to at least one photodetector, the receiver unit of the LiDAR sensor device also comprises a first and at least one second optical bandpass filter, in particular a narrowband optical bandpass filter, with the first and the at least one second optical bandpass filter being arranged between the object and the at least one photodetector. The first bandpass filter is configured to allow substantially light of the first wavelength and the at least one second bandpass filter is configured to allow substantially light of the at least one second wavelength to pass.

Essentially allowing light of the first wavelength and essentially allowing light of at least one second wavelength to pass should be understood to mean that the optical bandpass filters are each configured to essentially only allow signals of one wavelength band or passband to pass. Wavelength ranges below and above the passband, on the other hand, are blocked or at least significantly attenuated. In particular, the optical bandpass filters are configured in such a way that the wavelength band that they allow to pass essentially correlates with the light of a specific wavelength emitted by one of the emitters, in particular with light with a specific peak wavelength emitted by one of the emitters. The wavelength band can, for example, deviate only slightly from a wavelength or peak wavelength emitted by the emitters. For example, the wavelength band can only deviate by a maximum of ±10 nm, e.g., by a maximum of ±5 nm from a wavelength or peak wavelength emitted by the emitters.

In some embodiments, the first wavelength and the at least one second wavelength are in the near-infrared range. For example, the first and the at least one second wavelength each have a peak wavelength near or exactly at 850 nm, 905 nm, 940 nm or 980 nm. In particular, the peak wavelength of the first wavelength can thus differ from the peak wavelength of the second wavelength by at least 36 nm or at least 26 nm.

The first and the at least one second emitter can, for example, each be formed by a laser diode which is configured to emit light in the near-infrared range. In particular, the emitters can be configured to emit laser light with a specified peak wavelength in the near-infrared range. Due to manufacturing tolerances and manufacturing distribution, an actual peak wavelength emitted by the emitters can differ from a specified peak wavelength by up to ±7 nm, for example. The wavelength range emitted by the emitters can, for example, have a full width at half maximum (FWHM) of 12 nm (±6 nm).

Accordingly, the optical bandpass filters should be configured to essentially only allow signals of a wavelength band or passband to pass that are within the specified tolerances or the specified wavelength range. For example, for a peak wavelength of 905 nm specified by an emitter, it would result in the specific case according to the examples mentioned that a corresponding bandpass filter should have a passband of 905 nm−7 nm−6 nm=892 nm to 905 nm+7 nm+6 nm=918 nm, i.e. with a width of 26 nm.

In addition to this, however, standard emitters or laser diodes can experience a shift in the peak wavelength emitted by the emitter over a long operating period or a large temperature range in which the emitters are operated. In this specific case, the peak wavelength can shift by ±20 nm in a temperature range of −40° C. to 125° C., for example, compared to operation of the emitter at room temperature. For the exemplary calculation above, this would mean that for a peak wavelength of 905 nm specified by an emitter, a corresponding bandpass filter would have to have a passband of 905 nm−7 nm−6 nm−20 nm=872 nm to 905 nm+7 nm+6 nm=988 nm, i.e. with a width of 66 nm.

Since such an optical passband is relatively wide and can lead to undesired detected signals and thus to a falsification of the result, it may be desirable that the optical bandpass filters are also configured in such a way that they have a comparable behavior (T-shift behavior) to the emitters over a long operational period or a large temperature range in which the LiDAR sensor device is operated. This means that the bandpass filters experience a shift in the passband with a change in the temperature range in which the LiDAR sensor device is operated, in a manner comparable to the shift in the peak wavelength of the emitters in the same temperature range. This in turn can reduce the passband of the bandpass filter. In the case of the specific example calculated in advance, the passband of the bandpass filter could thus be reduced to 26 nm again.

Alternatively or in combination with this, the first and the at least one second laser emitter can each be formed by a wavelength-stabilized laser diode. A wavelength-stabilized laser diode is characterized in particular by providing narrowband and wavelength-stabilized emissions both over a long period of time and over a wide temperature range. For example, the first and the at least one second laser emitter are each configured to emit light in a narrowband wavelength range. The narrow-band wavelength range can, for example, have a full width at half maximum (FWHM) of at most 12 nm or at most 5 nm. In particular, the first and the at least one second laser emitter can, for example, each be configured to provide light in a correspondingly narrow wavelength range both over time and over a wide temperature range. Compared to standard laser diodes, the peak wavelength of a wavelength-stabilized laser diode in a temperature range of −40° C. to 125° C. can shift by only ±5 nm, for example, compared to operation of the wavelength-stabilized laser diode at room temperature.

For a peak wavelength of 905 nm specified by a wavelength-stabilized laser diode, it would result in the specific case according to the example calculated above that a corresponding bandpass filter should have a passband of 905 nm−7 nm−6 nm −5 nm=887 nm to 905 nm+7 nm+6 nm+5 nm=923 nm, i.e. a width of 36 nm. In combination with an optical bandpass filter, which is configured in such a way that it has a comparable behavior (T-shift behavior) to the laser diode over a long operational period or a large temperature range in which the LiDAR sensor device is operated, this passband could be reduced to 26 nm.

In some embodiments, the first and the at least one second optical bandpass filter are configured such that the wavelength band that they allow to pass correlates with a respective wavelength range of the light emitted by the laser emitters.

In some embodiments, the LiDAR sensor device additionally comprises a control unit configured to control the first and the at least one second laser emitter during a measurement cycle of the LiDAR sensor device and to process a signal detected by the at least one photodetector.

A measurement cycle can be defined by the time within which the LiDAR sensor device emits a defined number of light pulses in the direction of the object to determine the distance between the LiDAR sensor device and an object located in front of the sensor device and detects the light pulses reflected by the object. For example, a measurement cycle can comprise the emission of 1 to 15 light pulses of the first and/or the at least one second wavelength, as well as the detection of the light pulses reflected at the object.

A measurement cycle can, for example, have an emission window and a detection window. During the emission window, a defined number of light pulses are emitted in the direction of the object, whereas during the detection window, the light pulses reflected by the object are detected by the at least one photodetector. The emission window and the detection window may be the same length.

One possible solution for encoding the light emitted by the first and the at least one second emitter is, for example, that the control unit controls the first and the at least one second laser emitter per measurement cycle of the LiDAR sensor device according to a time-division multiplex method. The control unit thus controls the first and the at least one second emitter in predetermined sequence during an emission window per a measurement cycle in such a way that they emit a certain number of light pulses in the predetermined sequence during the emission window.

For example, five light pulses of the first (λ₁) and/or at least one second wavelength (λ₂) can be emitted during an emission window. A sequence of the emitted light pulses can be, for example:
λ₁, λ₁, λ₂, λ₁, λ₂;
λ₁, λ₂, λ₂, λ₂, λ₁;
λ₂, λ₁, λ₂, λ₁, λ₁;
λ₂, λ₂, λ₁, λ₁, λ₂;
. . .

[symbol]

However, more or fewer light pulses can also be emitted during an emission window and it is also possible that the frequency of the emitted light pulses, i.e. the time between the emitted light pulses, varies.

If the emission window in which the emitter or emitters have emitted light pulses is known, the at least one photodetector expects the reflected light pulses in the corresponding order during the detection window, thereby suppressing possible crosstalk of the sensor device and improving a signal-to-noise ratio of the detected signal.

An alternative or additional possibility for encoding the light emitted by the first and the at least one second emitter is that the control unit controls the first and the at least one second laser emitter per measurement cycle of the LiDAR sensor device according to a wavelength division multiplex method. The control unit thus controls the first and the at least one second emitter in parallel in a predetermined sequence during an emission window per measurement cycle so that they each emit a certain number of light pulses in the predetermined sequence during the emission window.

For example, light pulses of the first (λ₁) wavelength and light pulses of at least one second wavelength (λ₂) can be emitted simultaneously during an emission window. The frequency of the emitted light pulses, i.e. the time between the emitted light pulses, can vary both between the light pulses within a wavelength and between the different wavelengths. A sequence of the emitted light pulses can be, for example:
λ₁ & λ₂, λ₁, λ₁ & λ₂, λ₁, λ₁ & λ₂;
λ₁, λ₂, λ₁ & λ₂, λ₂,λ₁ & λ₂;
λ₂, λ₁, λ₁ & λ₂, λ₁ & λ₂, λ₁;
λ₂, λ₂, λ₁ & λ₂, λ₂, λ₂;
. . .

[symbol]

An alternative or additional possibility for encoding the light emitted by the first and the at least one second emitter is that the control unit varies the intensity of the light emitted by the first and/or the at least one second laser emitter per measurement cycle of the LiDAR sensor device. The control unit thus controls the first and/or the at least one second emitter during an emission window per measurement cycle in such a way that the first emitter emits light pulses with a different intensity than the at least one second emitter during the emission window.

In some embodiments, the control unit is configured to select the first or the at least one second wavelength as a measurement wavelength per measurement cycle of the LiDAR sensor device based on a reference signal detected by the at least one photodetector. In other words, the sensor device can be configured to perform a reference measurement per measurement cycle to check whether the first or the at least one second wavelength has a better signal-to-noise ratio for measuring the distance between the LiDAR sensor device and an object located in front of the sensor device. This reference measurement can then be used to determine whether the first or the at least one second wavelength is better suited for measuring the distance between the LiDAR sensor device and an object located in front of the sensor device. The better wavelength can then be selected as the measurement wavelength by the control unit. As soon as the sensor device detects a possible crosstalk/interference of one of its own emitted signals, another wavelength can be selected accordingly for measuring the distance between the LiDAR sensor device and an object located in front of the sensor device.

In some embodiments, the first and the at least one second optical bandpass filter are each formed by a narrow-band dielectric filter or by a dichroic filter, in particular a narrow-band dichroic filter. Dielectric filters, also known as interference filters, are optical components that use the effect of interference to filter light depending on the frequency. Such a filter has a different degree of reflection and transmission for light of different wavelengths, different angles incidence and sometimes different polarization. Dichroic filters are filters for color separation that are also based on dielectric interference. They are colored filters that reflect light of a certain wavelength and transmit light of other wavelengths. By superimposing several such filters, a filter can be created that only transmits light of a certain wavelength.

In some embodiments, the LiDAR sensor device additionally comprises a first optical element, in particular a lens and/or a MEMS mirror, which is arranged between the first and the at least one second laser emitter and the object. In particular, the first optical element can be configured to shape the light emitted by the laser emitters and/or to direct it in the direction of the object located in front of the laser emitters. For example, the optical element can comprise a lens which is configured to shape the light emitted by the laser emitters and to collimate it onto a beam deflection element, such as a MEMS mirror or a mechanical mirror. However, the optical element can also comprise so-called OPA's (optical phase arrays), which perform beam deflection of the light emitted by the laser emitters.

In some embodiments, the LiDAR sensor device additionally comprises a second optical element, in particular a lens and/or a MEMS mirror, which is arranged between the object and the at least one photodetector. In the event that the second optical element comprises a MEMS mirror, it may in particular be the same MEMS mirror that also forms the first optical element or is part thereof. The second optical element may, for example, be arranged between the object and the first and the at least one second optical bandpass filter, or the second optical element may be arranged between the first and the at least one second optical bandpass filter and the at least one photodetector. In the former case, the second optical element is configured to direct the light reflected from the object onto the first and the at least one second optical bandpass filter such that the first and the at least one second optical bandpass filter are fully illuminated with the light reflected from the object. In the second case, on the other hand, the second optical element is configured to direct the light reflected by the object and passing through the first and the at least one second optical bandpass filter onto the at least one photodetector in such a way that the at least one photodetector is fully illuminated with the light reflected by the object and passing through the first and the at least one second optical bandpass filter. It is also conceivable that the LiDAR sensor device comprises two second optical elements, wherein a second optical element may be arranged between the object and the first and the at least one second optical bandpass filter and the second optical element may be arranged between the first and the at least one second optical bandpass filter and the at least one photodetector.

In some embodiments, the at least one photodetector is formed with a pixelated array of a plurality of photodiodes. For example, the second optical element may be disposed between the first and the at least one second optical bandpass filter and the pixelated array and configured to direct the light reflected from the object and passed through the first and the at least one second optical bandpass filter onto the pixelated array such that the pixelated array is fully illuminated with the light reflected from the object and passed through the first and the at least one second optical bandpass filter.

In some embodiments, the pixelated array may comprise a first region comprising a first subset of the photodiodes that is adapted to detect light of the first wavelength that has passed through the first optical filter, and the pixelated array may comprise at least a second region comprising at least a second subset of the photodiodes that is adapted to detect light of the at least a second wavelength that has passed through the at least a second optical filter.

However, it is also possible that the LiDAR sensor device comprises a first photodetector and at least one second photodetector, each formed with a pixelated array of a plurality of photodiodes. The first photodetector may, for example, be intended to detect light of the first wavelength which has passed through the first optical filter and the at least one second photodetector may, for example, be intended to detect light of the at least one second wavelength which has passed through the at least one second optical filter.

The second optical element or several second optical elements can be arranged between the first and the at least one second optical bandpass filter and the pixelated array or the first and the at least one second photodetector and can be configured for this purpose, directing the light of different wavelengths reflected by the object and passing through the first and the at least one second optical bandpass filter onto different areas of the pixelated array or onto different photodetectors in such a way that the different areas of the pixelated array or the different photodetectors are each fully illuminated by the light of different wavelengths passing through the first and the at least one second optical bandpass filter.

The measuring method according to the at least one example of the present disclosure for determining the distance between a LiDAR sensor device and an object located in front of the sensor device includes the steps:
Emitting at least a first light pulse of a first wavelength and at least a second light pulse of at least a second wavelength different from the first wavelength in the direction of the object;
Detecting the light of the first and the at least one second wavelength reflected back from the object by means of at least one photodetector, wherein a first and at least one second optical bandpass filter, in particular a narrowband optical bandpass filter, are arranged between the object and the at least one photodetector, and wherein the first bandpass filter is configured to allow substantially light of the first wavelength to pass and the at least one second bandpass filter is configured to allow substantially light of the at least one second wavelength to pass.

In some embodiments, the measurement method comprises emitting a plurality of light pulses of the first and the at least one second wavelength per measurement cycle of the LiDAR sensor device according to a time division multiplexing method. Accordingly, light pulses of the first and the at least one second wavelength may be emitted in a predetermined order per measurement cycle, wherein the order, the number, and the frequency of the emitted light pulses per measurement cycle may vary.

For example, five light pulses of the first (λ₁) and/or at least one second wavelength (λ₂) can be emitted per measurement cycle. A sequence of the emitted light pulses can be, for example:
λ₁, λ₁, λ₂, λ₁, λ₂;
λ₁, λ₂, λ₂, λ₂, λ₁;
λ₂, λ₁, λ₂, λ₁, λ₁;
λ₂, λ₂, λ₁, λ₁, λ₂;
. . .

[symbol]

In some embodiments, the measurement method comprises emitting a plurality of light pulses of the first and the at least one second wavelength per measurement cycle of the LiDAR sensor device according to a wavelength division multiplex method. Accordingly, light pulses of the first and the at least one second wavelength can be emitted simultaneously or in parallel in a predetermined sequence per measurement cycle.

For example, light pulses of the first (λ₁) wavelength and light pulses of at least one second wavelength (λ₂) can be emitted simultaneously per measurement cycle. The frequency of the emitted light pulses, i.e. the time between the emitted light pulses, can vary both between the light pulses within a wavelength and between the different wavelengths. A sequence of the emitted light pulses can be, for example:
λ₁ & λ₂, λ₁, λ₁ & λ₂, λ₁, λ₁ & λ₂;
λ₁, λ₂, λ₁ & λ₂, λ₂, λ₁ & λ₂;
λ₂, λ₁, λ₁ & λ₂, λ₁ & λ₂, λ₁;
λ₂, λ₂, λ₁ & λ₂, λ₂, λ₂;
. . .

[symbol]

In some embodiments, the measurement method comprises emitting a plurality of light pulses of the first wavelength and the at least one second wavelength per measurement cycle of the LiDAR sensor device, wherein light pulses of the first wavelength have a different intensity than light pulses of the second wavelength.

By emitting light pulses according to a time-division multiplex method and/or according to a wavelength-division multiplex method and/or by emitting light pulses of different intensities, it is possible to encode the light emitted by the sensor device in the direction of the object in such a way that an echo signal reflected from an object and detected by the at least one photodetector can be clearly identified. A possible crosstalk of the sensor device can thus be suppressed and a signal-to-noise ratio of the detected signal can be improved.

In some embodiments, the at least one light pulse of the first wavelength and the at least one light pulse of the at least one second wavelength are emitted in series.

In some embodiments, the at least one light pulse of the first wavelength and the at least one light pulse of the at least one second wavelength are emitted simultaneously.

In some embodiments, the first and the at least one second wavelength are in the near-infrared range. In particular, the first and the at least one second wavelength have, for example, a peak wavelength at 850 nm, 905 nm or 940 nm.

In some embodiments, during a measurement cycle of the LiDAR sensor device, 1 to 15 light pulses of the first and the at least one second wavelength are emitted successively.

In some embodiments, the measurement method comprises selecting the first wavelength or the at least one second wavelength per measurement cycle of the LiDAR sensor device as a measurement wavelength for determining the distance between the LiDAR sensor device and the object in front of the sensor device based on a reference signal detected by the at least one photodetector.

The measurement method can include one reference measurement per measurement cycle to check whether the first or the at least one second wavelength has a better signal-to-noise ratio for measuring the distance between the LiDAR sensor device and an object located in front of the sensor device. This reference measurement can then be used to determine whether the first or the at least one second wavelength is better suited for measuring the distance between the LiDAR sensor device and an object located in front of the sensor device. The better wavelength can then be selected as the measurement wavelength by the control unit. As soon as the sensor device detects a possible crosstalk/interference of one of its own emitted signals, another wavelength can be selected accordingly for measuring the distance between the LiDAR sensor device and an object located in front of the sensor device.

### BRIEF DESCRIPTION OF THE DRAWINGS

In the following, embodiments of the present disclosure are explained in more detail with reference to the accompanying drawings. They show, in each case schematically,

FIG. 1 an illustration of a LiDAR sensor device according to some aspects of the proposed principle;

FIG. 2 an illustration of another LiDAR sensor device according to some aspects of the proposed principle; and

FIG. 3 an illustration of a signal pattern emitted by a LiDAR sensor device according to some aspects of the proposed principle.

### DETAILED DESCRIPTION

The following embodiments and examples show various aspects and their combinations according to the principles of the present disclosure. The embodiments and examples are not always to scale. Likewise, various elements may be shown enlarged or reduced in size in order to emphasize individual aspects. It is understood that the individual aspects and features of the embodiments and examples shown in the figures can be readily combined with each other without affecting principles of the present disclosure. Some aspects have a regular structure or shape. It should be noted that slight deviations from the ideal shape may occur in practice without, however, contradicting the inventive concept.

In addition, the individual figures, features and aspects are not necessarily shown in the correct size, and the proportions between the individual elements are not necessarily correct. Some aspects and features are emphasized by enlarging them. However, terms such as “above”, “above”, “below”, “below”, “larger”, “smaller” and the like are shown correctly in relation to the elements in the figures. It is thus possible to deduce such relationships between the elements on the basis of the figures.

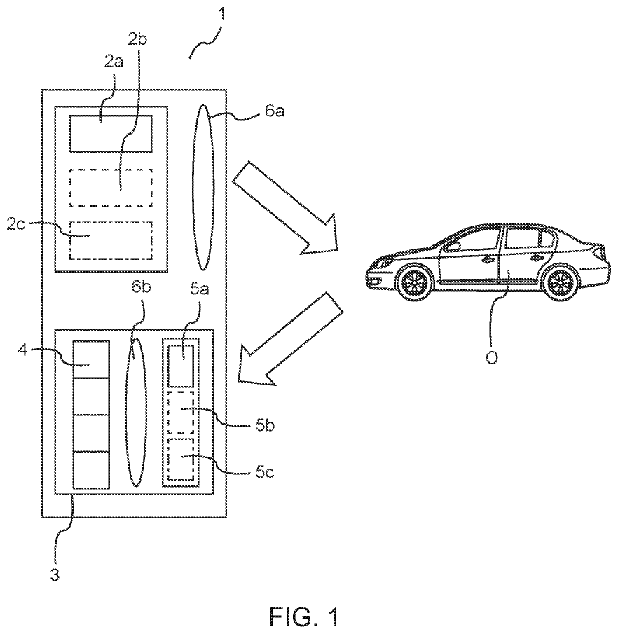

FIG. 1 shows a LiDAR sensor device 1 for determining the distance between the LiDAR sensor device and an object O located in front of the sensor device according to some aspects of the proposed principle. The sensor device 1 comprises a first, a second and a third laser emitter 2a, 2b, 2c. The first laser emitter 2a is configured to emit light pulses of a first wavelength λ₁, the second laser emitter 2b light pulses of a second wavelength λ₂, and the third laser emitter 2c light pulses of a third wavelength λ₃ in the direction of the object O located in front of the laser emitters 2a, 2b, 2c. The first, second and third wavelengths λ₁, λ₂, λ₃differ from each other. The first, second and third laser emitters 2a, 2b, 2c are accordingly configured to each emit light pulses with a different wavelength, in particular a different peak wavelength, in the direction of the object O located in front of the laser emitters 2a, 2b, 2c.

The light emitted by the laser emitters 2a, 2b, 2c is directed towards the object O by means of a first optical element 6a. The first optical element 6a can be a lens or a MEMs mirror, for example.

The LiDAR sensor device 1 can, for example, be arranged in a vehicle, in particular an autonomously driving vehicle, and the object O to which the distance is to be determined can, for example, be another road user in road traffic, such as another motor vehicle. However, the object O can also be an obstacle or, for example, a passer-by to whom the distance of the sensor device is to be measured.

The light pulses emitted by the laser emitters 2a, 2b, 2c in the direction of the object O located in front of the laser emitters 2a, 2b, 2c and directed towards the object O by means of the first optical element 6a are reflected at the object O and at least part of the light reflected at the object O is subsequently detected by means of a receiver unit 3. The distance between the sensor device 1 and the object O can be determined on the basis of the transit time of the light pulses from the sensor device 1 to the object O and back to the sensor device 1. Such a measurement of the distance between the sensor device and an object located in front of the sensor device can be referred to as a measurement cycle.

In addition to a pixelated photodetector 4, the receiver unit 3 has a first optical bandpass filter 5a, a second optical bandpass filter 5b and a third optical bandpass filter 5c. The first optical bandpass filter 5a is essentially configured to allow light with the first wavelength λ₁ to pass through, the second optical bandpass filter 5b essentially allows light with the second wavelength λ₂to pass through, and the third first optical bandpass filter 5c essentially allows light with the third wavelength λ₃ to pass through, which shines onto the bandpass filters.

The light pulses of the first, second and third wavelengths λ₁, λ₂, λ₃ transmitted by the optical bandpass filters 5a, 5b, 5c are directed towards the pixelated photodetector 4 by means of a second optical element 6b, so that it is fully or completely illuminated by the light pulses and can then detect the light pulses in the best possible way. The second optical element 6b can be a lens or a MEMs mirror, for example. For example, the second optical element 6b can be configured in such a way that light of the first wavelength λ₁, which is transmitted through the first optical bandpass filter 5a, light of the second wavelength λ₂, which is transmitted through the second optical bandpass filter 5b, and light of the third wavelength λ₃, which is transmitted through the third optical bandpass filter 5c, are each directed onto areas of the pixelated photodetector 4. This enables a wavelength-selective evaluation of the reflected or detected light.

The fact that the sensor device 1 is capable of emitting not only light pulses of a first wavelength λ₁, but in the case shown light pulses with three different wavelengths λ₁, λ₂, λ₃, and the fact that light reflected from the object can be filtered by means of the optical bandpass filters 5a, 5b, 5c can be used to filter light reflected from the object in such a way that essentially only light of the first, second and third wavelengths impinges on the detector, the distance between the sensor device 1 and the object can be measured in an improved manner.

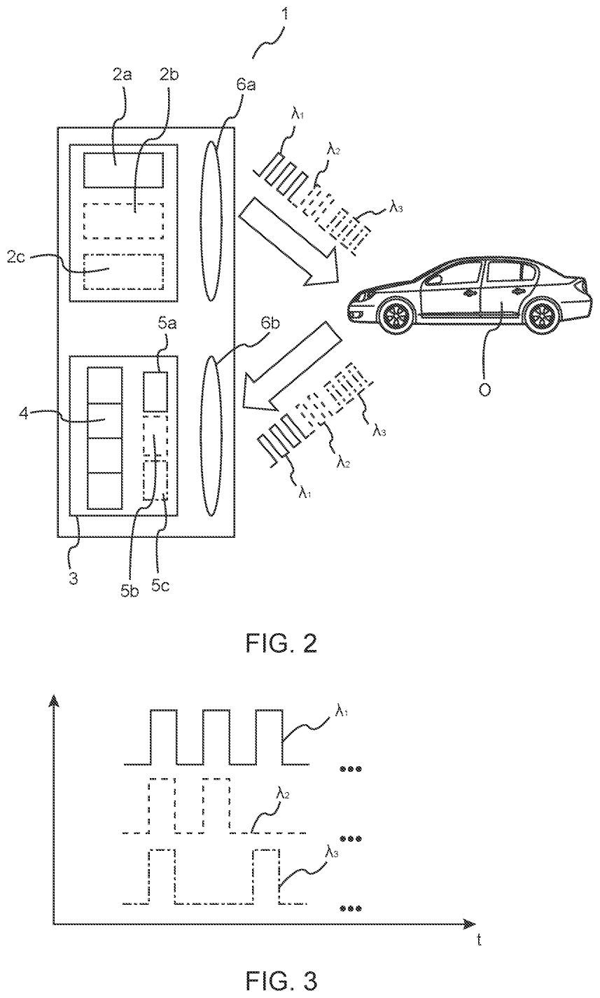

For example, the laser emitters 2a, 2b, 2c, which are configured to emit light pulses with the three different wavelengths λ₁, λ₂, λ₃, can be used to generate a coded signal pattern with which the sensor device 1 emits light in the direction of the object per measurement cycle. The echo signal reflected by the object O and detected by the receiver unit 3 in the form of the coded signal pattern can then be clearly assigned to the measurement cycle of the distance measurement and also has an improved signal-to-noise ratio. Coding can be carried out by means of a time-division multiplex method of the emitted light pulses, as shown in FIG. 2, by means of a wavelength-division multiplex method of the emitted light pulses, as shown in FIG. 3, or a combination of both methods (not shown).

Alternatively or additionally, thanks to the laser emitters 2a, 2b, 2c, which are configured to emit light pulses with the three different wavelengths λ₁, λ₂, λ₃, precisely the wavelength with the best signal-to-noise ratio can be selected from several different light pulses of different wavelengths emitted by the sensor device per measurement cycle as the measurement wavelength for determining the distance between the sensor device 1 and the object O. An upstream reference measurement can be used to check whether the first, second or third wavelength λ₁, λ₂, λ₃ has a better signal-to-noise ratio for the measurement. This reference measurement can then be used to determine whether the first, second or third wavelength λ₁, λ₂, λ₃ is more suitable for measuring the distance between the LiDAR sensor device and the object per measurement cycle.

FIG. 2 shows a further embodiment of a LiDAR sensor device 1 according to some aspects of the proposed principle. As already indicated above, the light emitted by the sensor device per measurement cycle in the direction of the object O is encoded in the form of a signal pattern for subsequent unambiguous identification. In the present case, the light pulses emitted are encoded by means of a time-division multiplexing process.

A measurement cycle has, for example, the emission window and detection window already mentioned. During the emission window, a defined number of light pulses are emitted in the direction of the object O, whereas during the detection window, the light pulses reflected by the object O are detected by the photodetector 4. In the case shown in FIG. 2, 8 light pulses (λ₁, λ₁, λ₁, λ₂, λ₂, λ₃, λ₃, λ₃) are emitted in the direction of the object O during the emission window and the light reflected from the object O is detected by the photodetector 4 with the corresponding signal pattern.

The emitted light pulses are encoded by means of a time-division multiplexing process in which the first, second and third laser emitters 2a, 2b, 2c emit a specific number of light pulses with the first second and third wavelengths λ₁, λ₂, λ₃in a predefined sequence during an emission window. By varying the sequence of the light pulses with the first second and third wavelengths λ₁, λ₂, λ₃, the respective number of light pulses with the first second and third wavelengths λ₁, λ₂, λ₃ during the emission window, and by varying the frequency of the emitted light pulses, i.e. the time between the emitted light pulses, the emitted light pulses can be clearly coded.

If the emission window in which the emitters 2a, 2b, 2c have emitted the light pulses is known, the photodetector 4 expects the reflected light pulses in the corresponding sequence during the detection window. Possible crosstalk of the sensor device 1 is thus suppressed and the signal-to-noise ratio of the detected signal is improved.

In the embodiment example shown in FIG. 2, the second optical element 6b is arranged between the object O and the optical bandpass filters 5a, 5b, 5c, contrary to the embodiment example shown in FIG. 1. The second optical element 6b can be configured accordingly to direct the light reflected by the object O in the direction of the optical bandpass filters 5a, 5b, 5c, so that these are completely or over their entire surface illuminated with the reflected light pulses.

FIG. 3 a representation of a signal pattern emitted by a LiDAR sensor device. In this case, the signal pattern is encoded by means of a wavelength division multiplexing process of the emitted light pulses. The diagram shows the signal pattern of the three laser emitters 2a, 2b, 2c with the three wavelengths λ₁, λ₂, λ₃ per measurement cycle over the time t.

For each measurement cycle, the three laser emitters 2a, 2b, 2c emit light pulses of the first, second and third wavelengths λ₁, λ₂, λ₃ partly simultaneously in a predetermined sequence. For example, light pulses of the first λ₁ wavelength and light pulses of the second and third wavelengths λ₂, λ₃ can be emitted simultaneously per measurement cycle. The frequency of the emitted light pulses, i.e. the time between the emitted light pulses, can vary both between the light pulses within a wavelength and between the different wavelengths. The exemplary sequence shown is, for example, λ₁ & λ₂ & λ₃, λ₁ & λ₂, λ₁ & λ₃. However, any other signal pattern generated by wavelength division multiplexing is also conceivable.

### REFERENCE LIST

1 LiDAR sensor device
2a first laser emitter
2b second laser emitter
2c third laser emitter
3 receiver unit
4 photodetector
5a first optical bandpass filter
5b second optical bandpass filter
5c third optical bandpass filter
6a first optical element
6b second optical element
λ₁ first wavelength
λ₂ second wavelength
λ₃ third wavelength
O object

1. A light detecting and ranging (LIDAR) sensor device, comprising:
a first laser emitter configured to emit pulsed light of a first wavelength and at least one second laser emitter configured to emit pulsed light of at least a second wavelength different from the first wavelength, in the direction of an object located in front of the laser emitters respectively; and
a receiving unit comprising at least one photodetector, a first optical bandpass filter, and at least one second optical bandpass filter, wherein each of the first optical bandpass filter and the at least one second optical bandpass filter comprises a narrowband optical bandpass filter, wherein the first and the at least one second optical bandpass filter are arranged between the object and the at least one photodetector, and wherein the first bandpass filter is configured to allow substantially light of the first wavelength to pass and the at least one second bandpass filter is configured to allow substantially light of the at least one second wavelength to pass.

2. The LIDAR sensor device according to claim 1,
wherein the first and at least one second wavelength are in the near-infrared range with a peak wavelength at 850 nm, 905 nm, 940 or 980 nm.

3. The LIDAR sensor device according to claim 1,
wherein the first and the at least one second laser emitter are each formed by a wavelength-stabilized laser diode.

4. The LIDAR sensor device according to claim 1,
wherein the first and the at least one second optical bandpass filter are each formed by a narrow-band dielectric filter or by a dichroic filter.

5. The LIDAR sensor device according to claim claim 1,
further comprising a first optical element comprising a lens or a MEMS mirror, which is arranged between the first and the at least one second laser emitter and the object.

6. The LIDAR sensor device according to claim 1,
further comprising a second optical element comprising a lens or a MEMS mirror, which is arranged between the object and the at least one photodetector.

7. The LIDAR sensor device according to claim 6,
wherein the second optical element is arranged between the object and the first and the at least one second optical bandpass filter.

8. The LIDAR sensor device according to claim 6,
wherein the second optical element is arranged between the first and the at least one second optical bandpass filter and the at least one photodetector.

9. The LIDAR sensor device according to claim 1,
wherein the at least one photodetector is formed of a pixelated array of a plurality of photodiodes.

10. The LIDAR sensor device according to claim 1,
further comprising a control unit configured to control the first and the at least one second laser emitter during a measurement cycle of the LIDAR sensor device and to process a signal detected by the at least one photodetector.

11. The LIDAR sensor device according to claim 10,
wherein the control unit is configured to control the first and the at least one second laser emitter per measurement cycle of the LIDAR sensor device according to a time-division multiplex method.

12. The LIDAR sensor device according to claim 10,
wherein the control unit is configured to control the first and the at least one second laser emitter per measurement cycle of the LIDAR sensor device in accordance with a wavelength division multiplexing method.

13. The LIDAR sensor device according to claims 10,
wherein the control unit is configured to vary the intensity of the light emitted by the first and the at least one second laser emitter for each measurement cycle of the LIDAR sensor device.

14. The LIDAR sensor device according to claim 10,
wherein the control unit is configured to select the first or the at least one second wavelength per measurement cycle of the LIDAR sensor device on the basis of a reference signal detected by the at least one photodetector as a measurement wavelength.

15. A measuring method for determining the distance between a LIDAR sensor device and an object located in front of the sensor device, comprising:
emitting at least one first light pulse of a first wavelength and at least one second light pulse of at least one second wavelength, which differs from the first wavelength, in the direction of the object;
detecting the light of the first and at least one second reflected back from the object by means of at least one photodetector, wherein a first and at least one second narrowband optical bandpass filter are arranged between the object and the at least one photodetector, and wherein the first bandpass filter is configured to transmit substantially light of the first wavelength and the at least one second bandpass filter is configured to transmit substantially light of the at least one second wavelength.

16. The measuring method according to claim 15,
further comprising emitting a plurality of light pulses of the first and the at least one second wavelength per measuring cycle of the LIDAR sensor device according to a time-division multiplex method.

17. The measuring method according to claim 15,
further comprising emitting a plurality of light pulses of the first and the at least one second wavelength per measurement cycle of the LIDAR sensor device according to a wavelength division multiplexing method.

18. The measuring method according to claim 15,
further comprising emitting a plurality of light pulses of the first and of the at least one second wavelength, wherein light pulses of the first wavelength have a different intensity than light pulses of the at least one second wavelength.

19. The measuring method according to claim 15,
wherein at least one light pulse of the first wavelength and at least one light pulse of the at least one second wavelength are emitted in series.

20. The measuring method according to claim 15,
wherein at least one light pulse of the first wavelength and at least one light pulse of the at least one second wavelength are emitted simultaneously.

21. The measuring method according to claims 15,
wherein the first and at least one second wavelength are in the near-infrared range with a peak wavelength of 850 nm, 905 nm or 940 nm.

22. The measuring method according to claim 15,
wherein 3 to 15 light pulses of the first and at least one second wavelength are successively emitted during a measurement cycle of the LIDAR sensor device.

23. The measuring method according to claim 15,
further comprising selecting the first wavelength or the at least one second wave-length as a measurement wavelength for determining the distance between the LIDAR sensor device and the object located in front of the sensor device on the basis of a reference signal detected by the at least one photodetector.
